(19) United States
(12) Patent Application Publication
(10) Pub. No.: US 2005/0203188 A1
(43) Pub. Date: Sep. 15, 2005

(54) Fungicidal mixtures based on benzamideoxime derivatives, benzophenones and on an azole

(76) Inventors: Eberhard Ammermann, Heppenheim (DE); Reinhard Stierl, Freinsheim (DE); Ulrich Schofl, Bruhl (DE); Siegfried Strathmann, Limburgerhof (DE); Klaus Schelberger, Gonnheim (DE); Maria Scherer, Godramstein (DE); Egon Haden, Kleinniedesheim (DE)

Correspondence Address: BIRCH STEWART KOLASCH & BIRCH, PO BOX 747, FALLS CHURCH, VA, 22040-0747, US

(21) Appl. No.: 10/516,674

(22) PCT Filed: Jun. 6, 2003
(86) PCT No.: PCT/EP03/05949

§ 371 Date: Dec. 6, 2004

(30) Foreign Application Priority Data
Jun. 20, 2002 (DE) 10227656.0

(51) Int. Cl. A01N 37/18; A01N 35/00

(52) U.S. Cl. 514/617; 514/686

(57) ABSTRACT

Fungicidal mixtures, comprising as active components
(1) a benzamideoxime derivative of the formula I 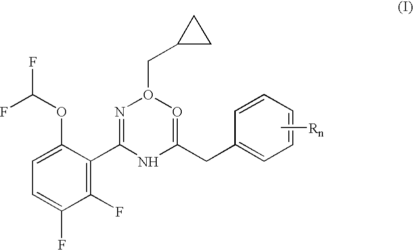 where the substituent and the index may have the following meanings:
R is hydrogen, halogen, C₁-C₄-alkyl, C₁-C₄-haloalkyl, C₁-C₄-alkoxy or C₁-C₄-haloalkoxy n is 1, 2 or 3, and
   (2) a benzophenone of the formula II, 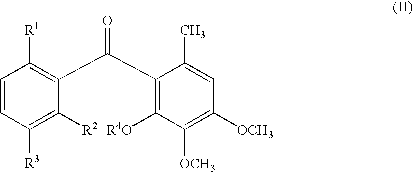 in which
R¹ is chlorine, methyl, methoxy, acetoxy, pivaloyloxy or hydroxyl;
R² is chlorine or methyl;
R³ is hydrogen, halogen or methyl; and
R⁴ is C₁-C₆-alkyl or benzyl, where the phenyl moiety of the benzyl radical may carry a halogen or methyl substituent, and
   (3) epoxiconazole of the formula III 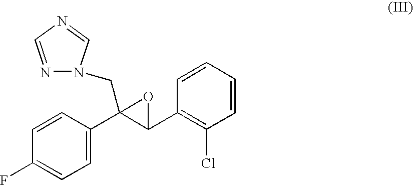 and, if appropriate,
   (4) pyraclostrobin of the formula IV 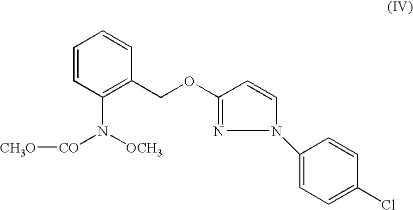 in a synergistically effective amount are described.

The present invention relates to fungicidal mixtures, comprising as active components
(1) a benzamideoxime derivative of the formula I 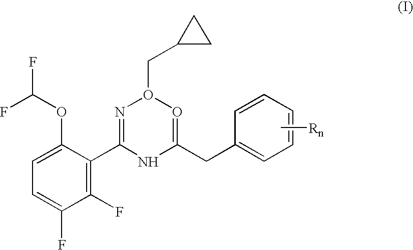
where the substituent and the index may have the following meanings:
R is hydrogen, halogen, C₁-C₄-alkyl, C₁-C₄-haloalkyl, C₁-C₄-alkoxy or C₁-C₄-haloalkoxy
n is 1, 2 or 3,
and
(2) a benzophenone of the formula II, 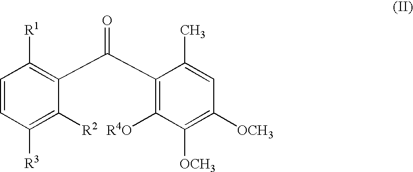
   in which
   R¹ is chlorine, methyl, methoxy, acetoxy, pivaloyloxy or hydroxyl;
   R² is chlorine or methyl;
   R³ is hydrogen, halogen or methyl; and
   R⁴ is C₁-C₆-alkyl or benzyl, where the phenyl moiety of the benzyl radical may carry a halogen or methyl substituent, and
(3) epoxiconazole of the formula III 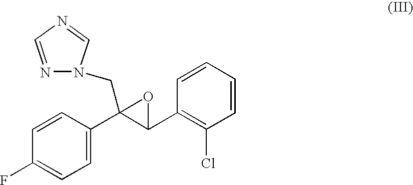
and, if appropriate,
(4) pyraclostrobin of the formula IV 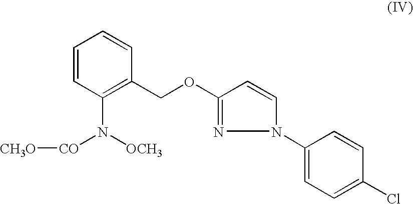
in a synergistically effective amount.

Moreover, the invention relates to a method for controlling harmful fungi using mixtures of the compounds I, II, III and, if appropriate, IV, and to the use of the compounds I, II, III and, if appropriate, IV for preparing such mixtures, and to compositions comprising these mixtures.

Benzamideoxime derivatives of the formula I are known from EP-A-1017670.

Fungicidal mixtures comprising, as active compound component, an azole, are known from EP-B 531,837, EP-A 645,091 and WO 97/06678.

The compounds of the formula II, their preparation and their action against harmful fungi are known from the literature (EP-A 727 141; EP-A 897 904; EP-A 899 255; EP-A 967 196).

Mixtures of benzophenones of the formula II with other fungicidally active compounds are known from EP-A 1 023 834.

Epoxiconazole of the formula III, its preparation and its action against harmful fungi are known per se from EP-A 196038.

Pyraclostrobin of the formula IV is known from EP-A 0 804 421.

It is an object of the present invention to provide further compositions for controlling harmful fungi and in particular for certain indications.

We have found that this object is achieved, surprisingly, by a mixture which comprises, as active compounds, benzamideoxime derivatives of the formula I defined at the outset and, as further fungicidally active components, a fungicidally active compound from the class of the benzophenones, azoles, and, if appropriate, strobilurins.

The mixtures according to the invention act synergistically and are therefore particularly suitable for controlling harmful fungi and in particular powdery mildew fungi in cereals, vegetables and grapevines.

In the context of the present invention, halogen denotes fluorine, chlorine, bromine and iodine, and in particular fluorine, chlorine and bromine.

The term “alkyl” includes straight-chain and branched alkyl groups. These are preferably straight-chain or branched C₁-C₄-alkyl groups. Examples of alkyl groups are alkyl such as, in particular, methyl, ethyl, propyl, 1-methylethyl, butyl, 1-methylpropyl, 2-methylpropyl and 1,1-dimethylethyl.

Haloalkyl denotes an alkyl group as defined above which is partially or fully halogenated by one or more halogen atoms, in particular by fluorine and chlorine. Preferably, 1 to 3 halogen atoms are present, and particular preference is given to the difluoromethyl and the trifluoromethyl groups.

What was said above for the alkyl group and haloalkyl group applies correspondingly to the alkyl and haloalkyl groups in alkoxy and haloalkoxy.

The radical R in the formula I preferably is a hydrogen atom.

The following compounds of the formula II are preferred mixing partners, the individual preferences applying on their own or in combination.

Preference is given to compounds II in which R¹ is chlorine, methoxy, acetoxy or hydroxyl, and particular preference is given to compounds in which R¹ is methoxy, acetoxy or hydroxyl. Very particular preference is given to compounds in which R¹ is methoxy.

Mixtures according to the invention comprise compounds II in which R² is chlorine or methyl. Preference is given to compounds II in which R² is methyl.

Moreover, preference is given to compounds II in which R³ is hydrogen, methyl, chlorine or bromine and with particular preference hydrogen, chlorine or bromine.

In addition, preference is given to compounds II in which R⁴ is C₁-C₄-alkyl or benzyl, where the phenyl moiety of the benzyl radical may carry a halogen or methyl substituent. Particularly preferred are compounds of the formula II in which R⁴ is C₁-C₄-alkyl, preferably methyl.

Preference is furthermore given to compounds of the formula II in which the substituents R¹, R², R³ and R⁴ are as defined below:
R¹ is methoxy, acetoxy or hydroxyl;
R² is methyl;
R³ is hydrogen, chlorine or bromine; and
R⁴ is C₁-C₄-alkyl.

Additionally, particular preference is given to compounds of the formula II in which the substituents have the meanings given in table 1 below:

| | |
|---|---|
| | II |
| 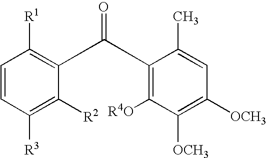 | |

| No. | R¹ | R² | R³ | R⁴ |
|---|---|---|---|---|
| II-1 | methoxy | Cl | H | methyl |
| II-2 | methoxy | Cl | methyl | methyl |
| II-3 | methoxy | Cl | H | n-propyl |
| II-4 | methoxy | Cl | H | n-butyl |
| II-5 | methoxy | Cl | H | benzyl |
| II-6 | methoxy | Cl | H | 2-fluorobenzyl |
| II-7 | methoxy | Cl | H | 3-fluorobenzyl |
| II-8 | methoxy | Cl | H | 4-fluorophenyl |
| II-9 | methoxy | Cl | H | 2-methylphenyl |
| II-10 | methoxy | Cl | H | 3-methylphenyl |
| II-11 | methoxy | Cl | H | 4-methylphenyl |
| II-12 | methoxy | Cl | Br | methyl |
| II-13 | methoxy | Cl | Br | n-propyl |
| II-14 | methoxy | Cl | Br | n-butyl |
| II-15 | methoxy | Cl | Br | benzyl |
| II-16 | methoxy | Cl | Br | 2-fluorobenzyl |
| II-17 | methoxy | methyl | H | methyl |
| II-18 | methoxy | methyl | Cl | methyl |
| II-19 | methoxy | methyl | H | n-propyl |
| II-20 | methoxy | methyl | H | n-butyl |
| II-21 | methoxy | methyl | H | benzyl |
| II-22 | methoxy | methyl | H | 2-fluorobenzyl |
| II-23 | methoxy | methyl | H | 3-fluorobenzyl |
| II-24 | methoxy | methyl | H | 4-fluorophenyl |
| II-25 | methoxy | methyl | H | 2-methylphenyl |
| II-26 | methoxy | methyl | H | 3-methylphenyl |
| II-27 | methoxy | methyl | H | 4-methylphenyl |
| II-28 | methoxy | methyl | Br | methyl |
| II-29 | methoxy | methyl | Br | n-propyl |
| II-30 | methoxy | methyl | Br | n-butyl |
| II-31 | methoxy | methyl | Br | benzyl |
| II-32 | methoxy | methyl | Br | 2-fluorobenzyl |
| II-33 | acetoxy | methyl | H | methyl |
| II-34 | acetoxy | methyl | Cl | methyl |
| II-35 | acetoxy | methyl | Br | methyl |
| II-36 | hydroxy | methyl | H | methyl |
| II-37 | hydroxy | methyl | Cl | methyl |
| II-38 | hydroxy | methyl | Br | methyl |
| II-39 | pivaloyloxy | methyl | H | methyl |
| II-40 | pivaloyloxy | methyl | Cl | methyl |
| II-41 | pivaloyloxy | methyl | Br | methyl |
| II-42 | Cl | Cl | H | methyl |
| II-43 | Cl | Cl | H | n-propyl |
| II-44 | Cl | Cl | H | n-butyl |
| II-45 | Cl | Cl | H | benzyl |
| II-46 | Cl | Cl | H | 2-fluorobenzyl |
| II-47 | Cl | Cl | H | 3-fluorobenzyl |
| II-48 | Cl | Cl | H | 4-fluorophenyl |
| II-49 | Cl | Cl | H | 2-methylphenyl |
| II-50 | Cl | Cl | H | 3-methylphenyl |
| II-51 | Cl | Cl | H | 4-methylphenyl |
| II-52 | Cl | Cl | Br | methyl |
| II-53 | Cl | Cl | Br | n-propyl |
| II-54 | Cl | Cl | Br | n-butyl |
| II-55 | Cl | Cl | Br | benzyl |
| II-56 | Cl | Cl | Br | 2-fluorobenzyl |
| II-57 | methyl | methyl | H | methyl |
| II-58 | methyl | methyl | H | n-propyl |
| II-59 | methyl | methyl | H | n-butyl |
| II-60 | methyl | methyl | H | benzyl |
| II-61 | methyl | methyl | H | 2-fluorobenzyl |
| II-62 | methyl | methyl | H | 3-fluorobenzyl |
| II-63 | methyl | methyl | H | 4-fluorophenyl |
| II-64 | methyl | methyl | H | 2-methylphenyl |
| II-65 | methyl | methyl | H | 3-methylphenyl |
| II-66 | methyl | methyl | H | 4-methylphenyl |
| II-67 | methyl | methyl | Br | methyl |
| II-68 | methyl | methyl | Br | n-propyl |
| II-69 | methyl | methyl | Br | n-butyl |
| II-70 | methyl | methyl | Br | benzyl |
| II-71 | methyl | methyl | Br | 2-fluorobenzyl |

The azole derivative in the mixtures according to the invention is epoxiconazole of the formula III. The mixtures according to the invention may additionally comprise pyraclostrobin of the formula IV.

For the synergistic action to unfold, even a small proportion of benzamideoxime derivative of the formula I is sufficient. Preferably, benzamideoxime derivative, benzophenone and epoxiconazole are employed in a weight ratio in the range from 20:1:1 to 1:20:20, in particular from 10:1:1 to 1:10:10.

Owing to the basic character of its nitrogen atoms, epoxiconazole of the formula III is capable of forming salts or adducts with inorganic or organic acids or with metal ions.

Examples of inorganic acids are hydrohalic acids, such as hydrogen fluoride, hydrogen chloride, hydrogen bromide and hydrogen iodide, carbonic acid, sulfuric acid, phosphoric acid and nitric acid.

Suitable organic acids are, for example, formic acid, and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals with 1 to 20 carbon atoms), arylsulfonic acids or aryldisulfonic acids (aromatic radicals, such as phenyl and naphthyl, which carry one or two sulfo groups), alkylphosphonic acids (phosphonic acids having straight-chain or branched alkyl radicals with 1 to 20 carbon atoms), arylphosphonic acids or aryldiphosphonic acids (aromatic radicals, such as phenyl and naphthyl, which carry one or two phosphonic acid radicals)., it being possible for the alkyl or aryl radicals to carry further substituents, for example p-toluenesulfonic acid, salicylic acid, p-aminosalicylic acid, 2-phenoxybenzoic acid, 2-acetoxybenzoic acid, etc.

Suitable metal ions are, in particular, the ions of the elements of the first to eighth transition groups, especially chromium, manganese, iron, cobalt, nickel, copper, zinc, and additionally those of the second main group, especially calcium and magnesium, and of the third and fourth main groups, in particular aluminum, tin and lead. If appropriate, the metals can be present in the various valences which they can assume.

If pyraclostrobin IV is employed, too, benzamideoxime derivative I, benzophenone II, epoxiconazole III and pyraclostrobin IV are employed in a weight ratio of from 20:1:1:1 to 1:20:20:20, preferably from 10:1:1:1 to 1:10:10:10.

When preparing the mixtures, it is preferred to employ the pure active compounds I to III and, if appropriate, IV, with which further active compounds against harmful fungi or other pests, such as insects, arachnids or nematodes, or else herbicidal or growth-regulating active compounds or fertilizers can be admixed.

The mixtures of the compounds I, II and III and, if appropriate, IV, or the simultaneous joint or separate use of the compounds I, II and III and, if appropriate, IV, have outstanding action against a wide range of phytopathogenic fungi, in particular from the classes of the Ascomycetes, Basidiomycetes, Phycomycetes and Deuteromycetes. Some of them act systemically and are therefore also suitable for use as foliar- and soil-acting fungicides.

They are especially important for controlling a large number of fungi in a variety of crop plants, such as cotton, vegetable species (for example cucumbers, beans, tomatoes, potatoes and cucurbits), barley, grass, oats, bananas, coffee, corn, fruit species, rice, rye, soya, grapevine, wheat, ornamentals, sugarcane, and a variety of seeds.

They are particularly suitable for controlling the following phytopathogenic fungi: Blumeria graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugarcane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in ground nuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

The mixtures according to the invention are particularly preferably used for controlling powdery mildew fungi in crops of cereals, grapevines and vegetables,, and also in ornamentals.

Compounds I, II, III and, if appropriate, IV can be applied simultaneously, that is either together or separately, or in succession, the sequence, in the case of separate application, generally not having any effect on the control results.

Depending on the desired effect, the application rates of the mixtures according to the invention are, in particular on areas under agricultural cultivation, from 0.01 to 8 kg/ha, preferably from 0.1 to 5 kg/ha, in particular from 0.5 to 3.0 kg/ha..

For the compounds I, the application rates are from 0.01. to 2.5 kg/ha, preferably from 0.05 to 2.5 kg/ha, in, particular from 0.1 to 1.0 kg/ha.

Correspondingly, the application rates for the compounds II and III and, if appropriate, IV are from 0.01 to 10 kg/ha, preferably from 0.05 to 5 kg/ha, in particular from 0.05 to 2.0 kg/ha.

For seed treatment, the application rates of the mixture are generally from 0.001 to 250 g/kg of seed, preferably from 0.01 to 100 g/kg, in particular from 0.01 to 50 g/kg.

If phytopathogenic harmful fungi are to be controlled, the separate or joint application of the compounds I, II, III and, if appropriate, IV or of the mixtures of the compounds I, II, III and, if appropriate, IV is effected by spraying or dusting the seeds, the plants or the soils before or after sowing of the plants, or before or after plant emergence.

The fungicidal synergistic mixtures according to the invention, or the compounds I, II, III and, if appropriate, IV, can be formulated, for example, in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in each case, it should ensure as fine and uniform a distribution as possible of the mixture according to the invention.

The formulations are prepared in a known manner, for example by extending the active compound with solvents and/or carriers, if desired using emulsifiers and dispersants, where, if the diluent used is water, it is also possible to use other, organic solvents as auxiliary solvents. Auxiliaries suitable for this purpose are essentially: solvents such as aromatic compounds (for example xylene), chlorinated aromatic compounds (for example chlorobenzenes), paraffins (for example mineral oil fractions), alcohols (for example methanol, butanol), ketones (for example cyclohexanone), amines (for example ethanolamine, dimethylformamide) and water; carriers, such as ground natural minerals (for example kaolins, clays, talc, chalk) and ground synthetic minerals (for example finely divided silica, silicates); emulsifiers, such as nonionic and anionic emulsifiers (for example polyoxyethylene fatty alcohol ethers, alkylsulfonates and arylsulfonates) and dispersants, such as lignosulfite waste liquors and methylcellulose.

Suitable surfactants are the alkali metal salts, alkaline earth metal salts and ammonium salts of aromatic sulfonic acids, for example ligno-, phenol-, naphthalene- and dibutylnaphthalenesulfonic acids, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenyl ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compounds I, II, III and, if appropriate, IV, or the mixture of the compounds I, II, III and, if appropriate, IV with a solid carrier.

Granules (for example coated granules, impregnated granules or homogeneous granules) are usually prepared by binding the active compound, or the active compounds, to a solid carrier.

Fillers or solid carriers are, for example, mineral earths, such as silica gel, silicic acids, silicates, talc, kaolin, limestone, lime, chalk, bole, loess, clay, dolomite, diatomaceous earth, calcium sulfate, magnesium sulfate, magnesium oxide, ground synthetic materials, and fertilizers, such as ammonium sulfate, ammonium phosphate, ammonium nitrate, ureas and products of vegetable origin, such as cereal meal, tree bark meal, wood meal and nutshell meal, cellulose powders or other solid carriers.

The formulations generally comprise from 0.1 to 95% by weight, preferably from 0.5 to 90% by weight, of one of the compounds I, II or III or, if appropriate, IV, or of the mixture of the compounds I, II and III and, if appropriate, IV. The active compounds are employed in a purity of from 90% to 100%, preferably from 95% to 100% (according to NMR spectrum or HPLC).

The compounds I, II, III or, if appropriate, IV, the mixtures or the corresponding formulations are applied by treating the harmful fungi, their habitat, or the plants, seeds, soils, areas, materials or spaces to be kept free from them with a fungicidally effective amount of the mixture, or of the compounds I, II and III and, if appropriate, IV, in the case of separate application.

Application can be effected before or after infection by the harmful fungi.

Examples of such preparations comprising the active compounds are:
I. a solution of 90 parts by weight of the active compounds and 10 parts by weight of N-methylpyrrolidone which is suitable for use in the form of microdrops;
II. a mixture of 20 parts by weight of the active compounds, 80 parts by weight of xylene, 10 parts by weight of the adduct of 8 to 10 mol of ethylene oxide to 1 mol of oleic acid N-monoethanolamide, 5 parts by weight of calcium dodecylbenzenesulfonate, 5 parts by weight of the adduct of 40 mol of ethylene oxide to 1 mol of castor oil; a dispersion is obtained by finely distributing the solution in water.
III. an aqueous dispersion of 20 parts by weight of the active compounds, 40 parts by weight of cyclohexanone, 30 parts by weight of isobutanol, 20 parts by weight of the adduct of 40 mol of ethylene oxide to 1 mol of castor oil;
IV. an aqueous dispersion of 20 parts by weight of the active compounds, 25 parts by weight of cyclohexanol, 65 parts by weight of a mineral oil fraction of boiling point 210 to 280° C. and 10 parts by weight of the adduct of 40 mol of ethylene oxide to 1 mol of castor oil;
V. a mixture, ground in a hammer mill, of 80 parts by weight of the active compounds, 3 parts by weight of sodium diisobutylnaphthalene-1-sulfonate, 10 parts by weight of a sodium lignosulfonate from a sulfite waste liquor and 7 parts by weight of pulverulent silica gel; a spray mixture is obtained by finely distributing the mixture in water;
VI. an intimate mixture of 3 parts by weight of the active compounds and 97 parts by weight of finely divided kaolin; this dust comprises 3% by weight of active compound;
VII. an intimate mixture of 30 parts by weight of the active compounds, 92 parts by weight of pulverulent silica gel and 8 parts by weight of paraffin oil which has been sprayed onto the surface of this silica gel; this preparation imparts good adhesion properties to the active compound;
VIII. a stable aqueous dispersion of 40 parts by weight of the active compounds, 10 parts by weight of the sodium salt of a phenolsulfonic acid/urea/formaldehyde condensate, 2 parts by weight of silica gel and 48 parts by weight of water, which can be diluted further;
IX. a stable oily dispersion of 20 parts by weight of the active compounds, 2 parts by weight of calcium dodecylbenzenesulfonate, 8 parts by weight of fatty alcohol polyglycol ether, 20 parts by weight of the sodium salt of a phenolsulfonic acid/urea/formaldehyde condensate and 88 parts by weight of a paraffinic mineral oil.

### USE EXAMPLE

The synergistic action of the mixtures according to the invention can be demonstrated by the following experiments:

The active compounds are prepared separately or together as a 10% strength emulsion in a mixture of 63% by weight of cyclohexanone and 27% by weight of emulsifier and diluted with water to the desired concentration.

Evaluation is carried out by determining the infected leaf areas in percent. These percentages are converted into efficacies. The efficacy (E) is calculated as follows using Abbot's formula:
E=(1−α)*100/β
α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the active compound mixtures were determined using Colby's formula [S. R. Colby, Weeds 15, 20-22 (1967)] and compared with the observed efficacies.
Colby's formula: E=x+y−x−y/100
E expected efficacy, expressed in % of the untreated control, when using the mixture of the active compounds A and B at the concentrations a and b
x efficacy, expressed in % of the untreated control, when using active compound A at a concentration of a
y efficacy, expressed in % of.the untreated control, when using active compound B at a concentration of b

### Use Example 1

### Activity Against Mildew of Wheat Caused by Erysiphe [syn. Blumeria] graminis Forma Specialis tritici

Leaves of potted wheat seedlings of the cultivar “Kanzler” were sprayed to runoff point with an aqueous suspension having the concentration of active compound stated below. The suspension or emulsion had been prepared from a stock solution comprising 10% of active compound in a mixture consisting of 85% of cyclohexanone and 5% of emulsifier. 24 hours after the spray coating had dried on, the seedlings were dusted with spores of mildew of wheat (Erysiphe [syn. Blumeria] graminis forma specialis tritici). The test plants were then placed in a greenhouse at temperatures between 20 and 24° C. and 60 to 90% relative atmospheric humidity. After 7 days, the extent of the mildew development was determined visually in % infection of the total leaf area.

The visually determined percentages of infected leaf area were converted into efficacies as % of the untreated control. An efficacy of 0 means the infection level of the treated plants corresponds to that of the untreated control; an efficacy of 100 means 0% infection. The expected efficacies of the combinations of active compounds were determined using Colby's formula (Colby, S. R. “Calculating synergistic and antagonistic responses of herbicide Combinations”, Weeds, 15, pp., 20-22, 1967) and compared with the observed efficacies.

TABLE 2

| | Concentration of | |
|---|---|---|
| | active compound in | Efficacy in % of |
| | the spray liquor | the untreated |
| Active compound | in ppm | control |
| Control (untreated) | (90% infection) | 0 |
| Compound I where Rₙ = H | 0.25 | 56 |
| | 0.06 | 33 |
| Compound II = metrafenone = | 1 | 72 |
| where R¹ = OCH₃, | 0.25 | 56 |
| R² = CH₃, R³ = Br, R⁴ = CH₃ | 0.06 | 44 |
| | 0.015 | 33 |
| Compound III = epoxiconazole | 1 | 56 |
| | 0.25 | 44 |
| | 0.06 | 33 |
| | 0.015 | 0 |
| Compound IV = pyraclostrobin | 1 | 33 |
| | 0.25 | 0 |
| | 0.06 | 0 |
| | 0.015 | 0 |

TABLE 3

| Two-component combination from | Observed | Calculated |
|---|---|---|
| EP 1 023 834 | efficacy | efficacy*) |
| Compound II = metrafenone + | 83 | 80 |
| compound III = epoxiconazole | | |
| 0.25 + 1 ppm mixture 1:4 | | |
| Compound II = metrafenone + | 78 | 69 |
| compound III = epoxiconazole | | |
| 0.06 + 0.25 ppm mixture 1:4 | | |
| Compound II = metrafenone + | 72 | 70 |
| compound III = epoxiconazole | | |
| 0.25 + 0.06 ppm mixture 4:1 | | |
| Compound II = metrafenone + | 67 | 44 |
| compound III = epoxiconazole | | |
| 0.06 + 0.015 ppm mixture 4:1 | | |

TABLE 4

| Two-component combination from | Observed | Calculated |
|---|---|---|
| WO 02/062140 | efficacy | efficacy*) |
| Compound I where Rₙ = H + | 78 | 75 |
| compound II = metrafenone | | |
| 0.25 + 0.06 ppm mixture 4:1 | | |
| Compound I = where Rₙ = H + | 67 | 56 |
| compound II = metrafenone | | |
| 0.06 + 0.015 ppm mixture 4:1 | | |
| Compound I = where Rₙ = H + | 89 | 88 |
| compound II = metrafenone | | |
| 0.25 + 1 ppm mixture 1:4 | | |
| Compound I = where Rₙ = H + | 72 | 70 |
| compound II = metrafenone | | |
| 0.06 + 0.25 ppm mixture 1:4 | | |

TABLE 5

| Two-component combination from | Observed | Calculated |
|---|---|---|
| WO 02/056686 | efficacy | efficacy*) |
| Compound II = metrafenone + | 78 | 70 |
| compound IV = pyraclostrobin | | |
| 0.25 + 1 ppm mixture 1:4 | | |
| Compound II = metrafenone + | 56 | 44 |
| compound IV = pyraclostrobin | | |
| 0.06 + 0.25 ppm mixture 1:4 | | |
| Compound II = metrafenone + | 78 | 56 |
| compound IV = pyraclostrobin | | |
| 0.25 + 0.06 ppm mixture 4:1 | | |
| Compound II = metrafenone + | 72 | 44 |
| compound IV = pyraclostrobin | | |
| 0.06 + 0.015 ppm mixture 4:1 | | |

TABLE 6

| Three-component combinations | Observed | Calculated |
|---|---|---|
| claimed | efficacy | efficacy*) |
| Compound I where Rₙ = H + compound | 100 | 93 |
| II = metrafenone + compound | | |
| III = epoxiconazole | | |
| from EP 1 023 834) | | |
| 0.25 + 0.25 + 1 ppm | | |
| mixture 1:1:4 | | |
| Compound I where Rₙ = H + compound | 97 | 85 |
| II = metrafenone + compound | | |
| III = epoxiconazole | | |
| 0.06 + 0.06 + 0.25 ppm | | |
| mixture 1:1:4 | | |
| Compound I where Rₙ = H + compound | 97 | 88 |
| II = metrafenone + compound | | |
| III = epoxiconazole | | |
| 0.25 + 0.25 + 0.06 ppm | | |
| mixture 4:4:1 | | |
| Compound I where Rₙ = H + compound | 94 | 78 |
| II = metrafenone + compound | | |
| III = epoxiconazole | | |
| 0.06 + 0.06 + 0.015 ppm | | |
| mixture 4:4:1 | | |
| Compound I where Rₙ = H + compound | 97 | 88 |
| II = metrafenone + compound | | |
| III = epoxiconazole | | |
| 0.25 + 0.06 + 0.25 ppm | | |
| mixture 4:1:4 | | |
| Compound I where Rₙ = H + compound | 87 | 78 |
| II = metrafenone + compound | | |
| III = epoxiconazole | | |
| 0.06 + 0.015 + 0.06 ppm | | |
| mixture 4:1:4 | | |
| Compound I where Rₙ = H + compound | 97 | 94 |
| II = metrafenone + compound | | |
| III = epoxiconazole | | |
| 0.25 + 1 + 0.25 ppm | | |
| mixture 1:4:1 | | |
| Compound I where Rₙ = H + compound | 94 | 81 |
| II = metrafenone + compound | | |
| III = epoxiconazole | | |
| 0.06 + 0.25 + 0.06 ppm | | |
| mixture 1:4:1 | | |
| Compound I where Rₙ = H + compound | 94 | 78 |
| II = metrafenone + compound | | |
| IV = pyraclostrobin | | |
| 0.25 + 0.06 + 0.25 ppm | | |
| mixture 4:1:4 | | |
| Compound I where Rₙ = H + compound | 78 | 67 |
| II = metrafenone + compound | | |
| IV = pyraclostrobin | | |
| 0.06 + 0.015 + 0.06 ppm | | |
| mixture 4:1:4 | | |
| Compound I where Rₙ = H + compound | 100 | 89 |
| II = metrafenone + compound | | |
| IV = pyraclostrobin | | |
| 0.25 + 1 + 0.25 ppm | | |
| mixture 1:4:1 | | |
| Compound I where Rₙ = H + compound | 83 | 72 |
| II = metrafenone + compound | | |
| IV = pyraclostrobin | | |
| 0.06 + 0.25 + 0.06 ppm | | |
| mixture 1:4:1 | | |
| Compound I where Rₙ = H + compound | 99 | 90 |
| II = metrafenone + compound | | |
| IV = pyraclostrobin | | |
| 0.25 + 0.25 + 1 ppm | | |
| mixture 1:1:4 | | |
| Compound I where Rₙ = H + compound | 83 | 70 |
| II metrafenone + compound | | |
| IV = pyraclostrobin | | |
| 0.06 + 0.06 + 0.25 ppm | | |
| mixture 1:1:4 | | |
| Compound I where Rₙ = H + compound | 100 | 90 |
| II = metrafenone + compound | | |
| IV = pyraclostrobin | | |
| 0.25 + 0.25 + 0.06 ppm | | |
| mixture 4:4:1 | | |
| Compound I where Rₙ = H + compound | 94 | 81 |
| II = metrafenone + compound | | |
| IV = pyraclostrobin | | |
| 0.06 + 0.06 + 0.015 ppm | | |
| mixture 4:4:1 | | |

### Use Example 2

### Curative Activity Against Brown Rust of Wheat Caused by Puccinia recondita

Curative Activity Against Brown Rust of Wheat Caused by Puccinia recondita

Leaves of potted wheat seedlings of the cultivar “Kanzler” were dusted with spores of brown rust (Puccinia recondita). The pots were then placed in a chamber with high atmospheric humidity (90 to 95%), at 20 to 22° C., for 24 hours. During this period of time, the spores germinated and the germinal tubes penetrated into the leaf tissue. The next day, the infected plants were sprayed to runoff point with an aqueous suspension having the concentration of active compound stated below. The suspension or emulsion had been prepared from a stock solution comprising 10% of active compound in a mixture consisting of 85% of cyclohexanone and 5% of emulsifier. After the spray coating had dried on, the test plants were cultivated in a greenhouse at temperatures between 20 and 22° C. and at 65 to 70% relative atmospheric humidity for 7 days. The extent of the rust fungus development on the leaves was then determined.

The visually determined percentages of infected leaf areas were converted into efficacies as % of the untreated control. An efficacy of 0 means that the infection level of the treated plants corresponds to that of the untreated control; an efficacy of 100 means 0% infection. The expected efficacies of the combinations of active compounds were determined using Colby's formula (Colby, S. R. “Calculating synergistic and antagonistic responses of herbicide Combinations”, Weeds, 15, pp. 20-22, 1967) and compared with the observed efficacies.

TABLE 7

| | Concentration of | Efficacy |
|---|---|---|
| | active compound | in % of |
| | in the spray | the untreated |
| Active compound | liquor in ppm | control |
| Control (untreated) | (90% infection) | 0 |
| Compound I where Rn = H | 0.25 | 0 |
| | 0.06 | 0 |
| Compound II = metrafenone = where | 1 | 0 |
| R¹ = OCH₃, R² = CH₃, R³ = Br, | 0.25 | 0 |
| R⁴ = CH₃ | 0.06 | 0 |
| | 0.015 | 0 |
| Compound III = epoxiconazole | 1 | 94 |
| | 0.25 | 89 |
| | 0.06 | 67 |
| | 0.015 | 0 |
| Compound IV = pyraclostrobin | 1 | 78 |
| | 0.25 | 33 |
| | 0.06 | 33 |
| | 0.015 | 22 |

TABLE 8

| Two-component combination from | Observed | Calculated |
|---|---|---|
| EP 1 023 834 | efficacy | efficacy*) |
| Compound II = metrafenone + | 97 | 94 |
| compound III = epoxiconazole | | |
| 0.25 + 1 ppm mixture 1:4 | | |
| Compound II = metrafenone + | 94 | 89 |
| compound III = epoxiconazole | | |
| 0.06 + 0.25 ppm mixture 1:4 | | |
| Compound II = metrafenone + | 83 | 67 |
| compound III = epoxiconazole | | |
| 0.25 + 0.06 ppm mixture 4:1 | | |
| Compound II = metrafenone + | 33 | 0 |
| compound III = epoxiconazole | | |
| 0.06 + 0.015 ppm mixture 4:1 | | |

TABLE 9

| Two-component combination from | Observed | Calculated |
|---|---|---|
| WO 02/062140 | efficacy | efficacy*) |
| Compound I = where Rₙ = H + | 0 | 0 |
| compound II = metrafenone | | |
| 0.25 + 0.06 ppm mixture 4:1 | | |
| Compound I = where Rₙ = H + | 0 | 0 |
| compound II = metrafenone | | |
| 0.06 + 0.015 ppm mixture 4:1 | | |
| Compound I = where Rₙ = H + | 0 | 0 |
| compound II = metrafenone | | |
| 0.25 + 1 ppm mixture 1:4 | | |
| Compound I = where Rₙ = H + | 0 | 0 |
| compound II = metrafenone | | |
| 0.06 + 0.25 ppm mixture 1:4 | | |

TABLE 10

| Two-component combination from | Observed | Calculated |
|---|---|---|
| WO 02/056686 | efficacy | efficacy*) |
| Compound II = metrafenone + | 89 | 78 |
| compound IV = pyraclostrobin | | |
| 0.25 + 1 ppm mixture 1:4 | | |
| Compound II = metrafenone + | 56 | 33 |
| compound IV = pyraclostrobin | | |
| 0.06 + 0.25 ppm mixture 1:4 | | |
| Compound II = metrafenone + | 56 | 33 |
| compound IV = pyraclostrobin | | |
| 0.25 + 0.06 ppm mixture 4:1 | | |
| Compound II = metrafenone + | 44 | 22 |
| compound IV = pyraclostrobin | | |
| 0.06 + 0.015 ppm mixture 4:1 | | |

TABLE 11

| Three-component combinations | Observed | Calculated |
|---|---|---|
| claimed | efficacy | efficacy*) |
| Compound I where Rₙ = H + compound | 100 | 97 |
| II = metrafenone + compound | | |
| III = epoxiconazole | | |
| 0.25 + 0.25 + 1 ppm | | |
| mixture 1:1:4 | | |
| Compound I where Rₙ = H + compound | 100 | 94 |
| II = metrafenone + compound | | |
| III = epoxiconazole | | |
| 0.06 + 0.06 + 0.25 ppm | | |
| mixture 1:1:4 | | |
| Compound I where Rₙ = H + compound | 94 | 83 |
| II = metrafenone + compound | | |
| III = epoxiconazole | | |
| 0.25 + 0.25 + 0.06 ppm | | |
| mixture 4:4:1 | | |
| Compound I where Rₙ = H + compound | 56 | 33 |
| II = metrafenone + compound | | |
| III = epoxiconazole | | |
| 0.06 + 0.06 + 0.015 ppm | | |
| mixture 4:4:1 | | |
| Compound I where Rₙ = H + compound | 100 | 89 |
| II = metrafenone + compound | | |
| III = epoxiconazole | | |
| 0.25 + 0.06 + 0.25 ppm | | |
| mixture 4:1:4 | | |
| Compound I where Rₙ = H + compound | 83 | 67 |
| II = metrafenone + compound | | |
| III = epoxiconazole | | |
| 0.06 + 0.015 + 0.06 ppm | | |
| mixture 4:1:4 | | |
| Compound I where Rₙ = H + compound | 100 | 89 |
| II = metrafenone + compound | | |
| III = epoxiconazole | | |
| 0.25 + 1 + 0.25 ppm | | |
| mixture 1:4:1 | | |
| Compound I where Rₙ = H + compound | 78 | 67 |
| II = metrafenone + compound | | |
| III = epoxiconazole | | |
| 0.06 + 0.25 + 0.06 ppm | | |
| mixture 1:4:1 | | |
| Compound I where Rₙ = H + compound | 56 | 33 |
| II = metrafenone + compound | | |
| IV = pyraclostrobin | | |
| 0.25 + 0.06 + 0.25 ppm | | |
| mixture 4:1:4 | | |
| Compound I where Rₙ = H + compound | 44 | 33 |
| II = metrafenone + compound | | |
| IV = pyraclostrobin | | |
| 0.06 + 0.015 + 0.06 ppm | | |
| mixture 4:1:4 | | |
| Compound I where Rₙ = H + compound | 67 | 33 |
| II = metrafenone + compound | | |
| IV = pyraclostrobin | | |
| 0.25 + 1 + 0.25 ppm | | |
| mixture 1:4:1 | | |
| Compound I where Rₙ = H + compound | 50 | 33 |
| II = metrafenone + compound | | |
| IV = pyraclostrobin | | |
| 0.06 + 0.25 + 0.06 ppm | | |
| mixture 1:4:1 | | |
| Compound I where Rₙ = H + compound | 97 | 89 |
| II = metrafenone + compound | | |
| IV = pyraclostrobin | | |
| 0.25 + 0.25 + 1 ppm | | |
| mixture 1:1:4 | | |
| Compound I where Rₙ = H + compound | 72 | 56 |
| II = metrafenone + compound | | |
| IV = pyraclostrobin | | |
| 0.06 + 0.06 + 0.25 ppm | | |
| mixture 1:1:4 | | |
| Compound I where Rₙ = H + compound | 67 | 56 |
| II = metrafenone + compound | | |
| IV = pyraclostrobin | | |
| 0.25 + 0.25 + 0.06 ppm | | |
| mixture 4:4:1 | | |
| Compound I where Rₙ = H + compound | 56 | 44 |
| II = metrafenone + compound | | |
| IV = pyraclostrobin | | |
| 0.06 + 0.06 + 0.015 ppm | | |
| mixture 4:4:1 | | |

*)efficacy calculated using Colby's formula

The test results show that for all mixing ratios the observed efficacy is higher than the efficacy predicted using Colby's formula (from Synerg 188. XLS).

1. A fungicidal mixture, comprising as active components
(1) a benzamideoxime derivative of the formula I. 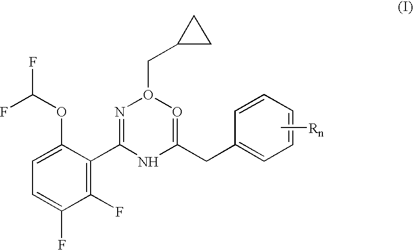
where the substituent and the index may have the following meanings:.
R is hydrogen, halogen, C₁-C₄-alkyl, C₁-C₄-haloalkyl, C₁-C₄-alkoxy or C₁-C₄-haloalkoxy
n is 1, 2 or 3,
and
(2) a benzophenone of the formula II, 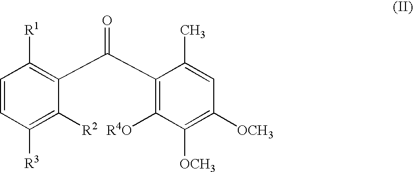
in which
R¹ is chlorine, methyl, methoxy, acetoxy, pivaloyloxy or hydroxyl;
R² is chlorine or methyl;
R³ is hydrogen, halogen or methyl; and
R⁴ is C₁-C₆-alkyl or benzyl, where the phenyl moiety of the benzyl radical may carry a halogen or methyl substituent, and
(3) epoxiconazole of the formula III 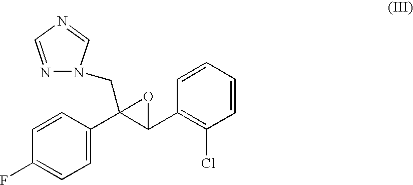
in a synergistically effective amount.

2. A fungicidal mixture as claimed in claim 1, furthermore comprising
(4) pyraclostrobin of the formula IV

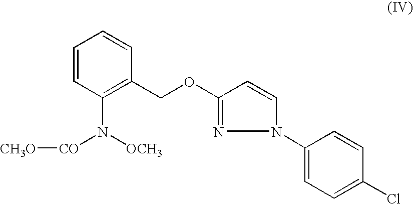

3. A fungicidal mixture as claimed in claim 1, where the radical R in the formula I is hydrogen.

4. A fungicidal mixture as claimed in any of claims 1 to 3, where in the formula II
R¹ is methoxy, acetoxy or hydroxyl,
R² is methyl,
R³ is hydrogen, chlorine or bromine, and
R⁴ is C₁-C₄-alkyl.

5. A fungicidal mixture as claimed in claim 4, where in the formula II
R¹ is methoxy,
R², R⁴ are methyl and
R³ is bromine;

6. A fungicidal mixture as claimed in claim 1, where the weight ratio of the benzamideoxime derivative of the formula I to the benzophenone of the formula II and the epoxiconazole of the formula III is from 20:1:1 to 1:20:20.

7. A method for controlling harmful fungi, which comprises treating the harmful fungi, their habitat, or the plants, seeds, soils, areas, materials or spaces to be kept free from them with the fungicidal mixture as claimed in claim 1.

8. A method as claimed in claim 7, which comprises applying the compounds of the formulae I, II and III as set forth in claim 1 simultaneously, that is either together or separately, or in succession.

9. A method as claimed in claim 7 or 8, wherein the fungicidal mixture or the compounds of the formulae I, II and III are applied in an amount of from 0.01 to 8 kg/ha.

10. A fungicidal composition, comprising the fungicidal mixture as claimed in claim 1 and a solid or liquid carrier.
